(19) United States
(12) Patent Application Publication
(10) Pub. No.: US 2019/0026588 A1
(43) Pub. Date: Jan. 24, 2019

(54) CLASSIFICATION METHODS AND SYSTEMS

(71) Applicant: GM GLOBAL TECHNOLOGY OPERATIONS LLC, Detroit, MI (US)

(72) Inventor: Lawrence Oliver Ryan, Menlo Park, CA (US)

(73) Assignee: GM GLOBAL TECHNOLOGY OPERATIONS LLC, Detroit, MI (US)

(21) Appl. No.: 15/654,246

(22) Filed: Jul. 19, 2017

(51) Int. Cl. G06K 9/32; G06K 9/00; G05D 1/00; G01S 17/93; B60R 1/00; G01S 17/02

(52) U.S. Cl. CPC G06K 9/3241; G06K 9/00201; G06K 9/00805; G05D 1/0088; B60R 2300/30; B60R 1/00; G01S 17/023; G05D 1/0055; G06K 9/00791; G01S 17/936

(57) ABSTRACT

Systems and method are provided for classifying an object. In one embodiment, a method includes receiving sensor data associated with an environment of a vehicle; processing, by a processor, the sensor data to determine an element within a scene; generating, by the processor, a bounding box around the element; projecting, by the processor, segments of the element onto the bounding box to obtain a depth image; and classifying the object by providing the depth image to a machine learning model and receiving a classification output that classifies the element as an object for assisting in control of the autonomous vehicle.

### TECHNICAL FIELD

The present disclosure generally relates to autonomous vehicles, and more particularly relates to systems and methods for classifying objects and controlling the autonomous vehicle based on the classification of the object.

### INTRODUCTION

An autonomous vehicle is a vehicle that is capable of sensing its environment and navigating with little or no user input. An autonomous vehicle senses its environment using sensing devices such as radar, lidar, image sensors, and the like. The autonomous vehicle system further uses information from global positioning systems (GPS) technology, navigation systems, vehicle-to-vehicle communication, vehicle-to-infrastructure technology, and/or drive-by-wire systems to navigate the vehicle.

Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

While recent years have seen significant advancements in AVs, such systems might still be improved in a number of respects. For example, it would be advantageous for an AV to be capable of more accurately classifying an object sensed in its surroundings—e.g., whether an object sensed in the environment is a human being, an automotive vehicle, or the like.

Accordingly, it is desirable to provide systems and methods that are capable of more accurately classifying objects sensed in the environment. Furthermore, other desirable features and characteristics of the present invention will become apparent from the subsequent detailed description and the appended claims, taken in conjunction with the accompanying drawings and the foregoing technical field and background.

### SUMMARY

Systems and method are provided for classifying an object. In one embodiment, a method includes receiving sensor data associated with an environment of a vehicle; processing, by a processor, the sensor data to determine an element within a scene; generating, by the processor, a bounding box around the element; projecting, by the processor, segments of the element onto the bounding box to obtain a depth image; and classifying the object by providing the depth image to a machine learning model and receiving a classification output that classifies the element as an object for assisting in control of the autonomous vehicle.

In one embodiment, a system includes an object classification module, including a processor. The object classification module is configured to, via the processor, receive sensor data associated with an environment of a vehicle; process, by a processor, the sensor data to determine an element within a scene; generate, by the processor, a bounding box around the element; project, by the processor, segments of the element onto the bounding box to obtain a depth image; and classify the object by providing the depth image to a machine learning model and receiving a classification output that classifies the element as an object for assisting in control of the autonomous vehicle.

In one embodiment, an autonomous vehicle is provided. The autonomous vehicle includes at least one sensor that provides sensor data; and a controller that, by a processor and based on the sensor data: receives sensor data associated with an environment of a vehicle; processes, by a processor, the sensor data to determine an element within a scene; generates, by the processor, a bounding box around the element; projects, by the processor, segments of the element onto the bounding box to obtain a depth image; and classifies the object by providing the depth image to a machine learning model and receiving a classification output that classifies the element as an object for assisting in control of the autonomous vehicle.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having an object classification system, in accordance with various embodiments;

FIG. 2 is a functional block diagram illustrating a transportation system having one or more autonomous vehicles of FIG. 1, in accordance with various embodiments;

FIGS. 3 and 4 are dataflow diagrams illustrating an autonomous driving system that includes the object classification system of the autonomous vehicle, in accordance with various embodiments; and

FIG. 5 is a flowchart illustrating a control method for controlling the autonomous vehicle according, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

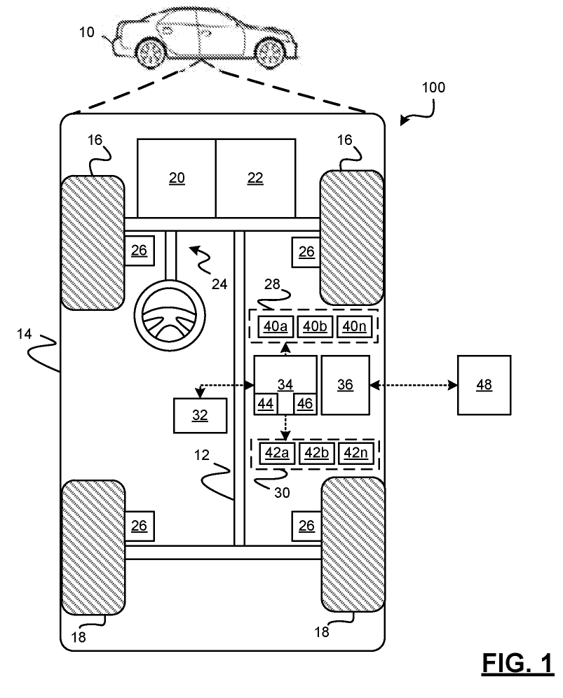

With reference to FIG. 1, an object classification system shown generally at 100 is associated with a vehicle 10 in accordance with various embodiments. In general, the object classification system 100 receives data sensed from an environment of the vehicle, processes the received data to identify elements in the environment, classifies the elements into objects, and intelligently controls the vehicle 10 based thereon. In order to classify the elements, the object classification system 100 includes a machine learning (ML) model (e.g., a neural network) capable of classifying objects in the vicinity of vehicle 10 based on a bounding box assigned to an element and information obtained from the data within the box and the bounding box. For example, segments of the element within the box are projected against the sides of the box to obtain an interpolated depth image with respect to the box. Data within the box is evaluated to determine a histogram of elevation and a histogram of height. The ML model processes the interpolated depth image and the histograms and generates a classification of the element as an object.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the classification system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

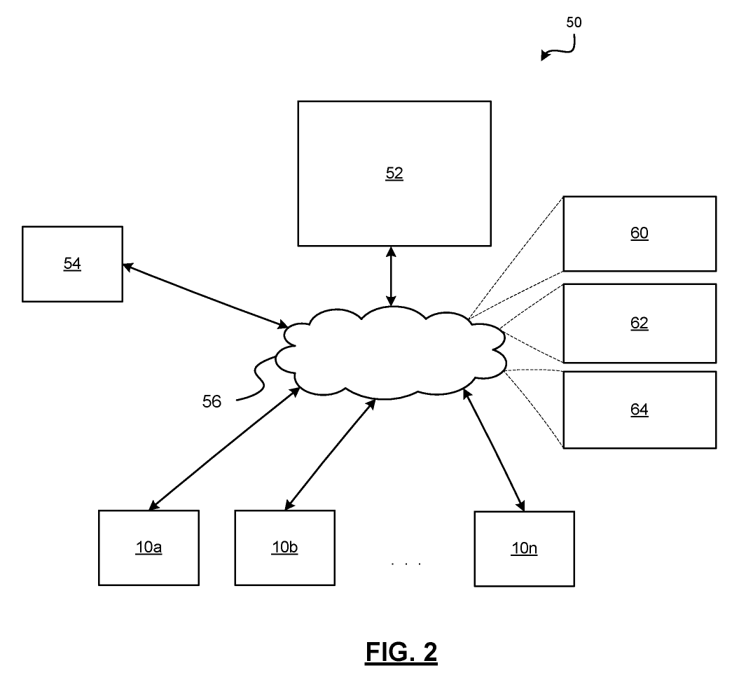

The communication system 36 is configured to wirelessly communicate information to and from other entities 48, such as but not limited to, other vehicles (“V2V” communication,) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, as discussed in detail below, one or more instructions of the controller 34 are embodied in the classification system 100 and, when executed by the processor 44, classify objects in the environment using a ML model that has been previously trained based on depth information associated with a bounding box of an element and other information.

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous vehicle based remote transportation system. FIG. 2 illustrates an exemplary embodiment of an operating environment shown generally at 50 that includes an autonomous vehicle based remote transportation system 52 that is associated with one or more autonomous vehicles 10a-10n as described with regard to FIG. 1. In various embodiments, the operating environment 50 further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 can include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a piece of home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, which may be cloud-based, network-based, or resident at the particular campus or geographical location serviced by the remote transportation system 52. The remote transportation system 52 can be manned by a live advisor, or an automated advisor, or a combination of both. The remote transportation system 52 can communicate with the user devices 54 and the autonomous vehicles 10a-10n to schedule rides, dispatch autonomous vehicles 10a-10n, and the like. In various embodiments, the remote transportation system 52 stores account information such as subscriber authentication information, vehicle identifiers, profile records, behavioral patterns, and other pertinent subscriber information.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The remote transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

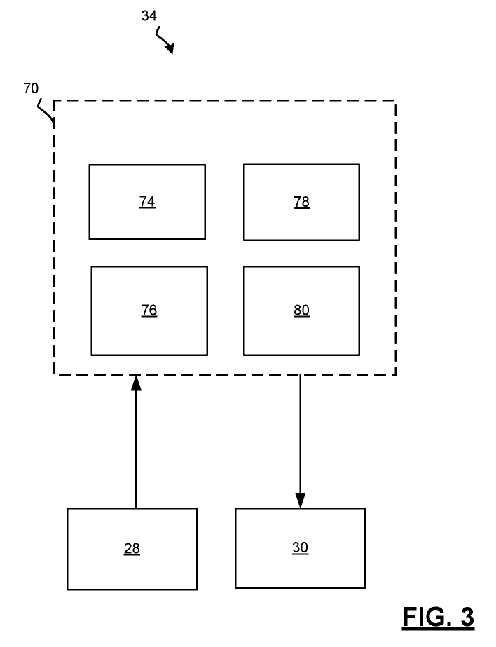

Referring now to FIG. 3, and with continued reference to FIG. 1, a dataflow diagram illustrates various embodiments of an autonomous driving system (ADS) 70 which may be embedded within the controller 34 and which may include parts of the object classification system 100 in accordance with various embodiments. That is, suitable software and/or hardware components of controller 34 (e.g., processor 44 and computer-readable storage device 46) are utilized to provide an autonomous driving system 70 that is used in conjunction with vehicle 10.

Inputs to the autonomous driving system 70 may be received from the sensor system 28, received from other control modules (not shown) associated with the autonomous vehicle 10, received from the communication system 36, and/or determined/modeled by other sub-modules (not shown) within the controller 34. In various embodiments, the instructions of the autonomous driving system 70 may be organized by function or system. For example, as shown in FIG. 3, the autonomous driving system 70 can include a sensor fusion system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the sensor fusion system 74 synthesizes and processes sensor data and predicts the presence, location, classification, and/or path of objects and features of the environment of the vehicle 10. In various embodiments, the sensor fusion system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as obstruction mitigation, route traversal, mapping, sensor integration, ground-truth determination, and feature detection, and object classification as discussed herein.

As mentioned briefly above, object classification system 100 of FIG. 1 classifies objects in the vicinity of vehicle 10 and controls the vehicle based thereon. All or parts of the object classification system 100 may be included within the positioning system 76, the guidance system 78, and the vehicle control system 80.

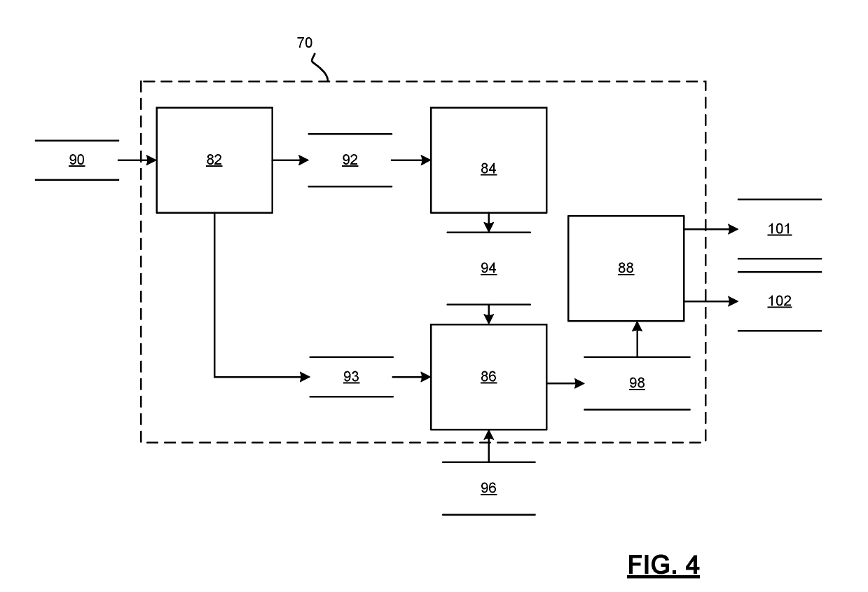

For example, as shown in more detail with regard to FIG. 4 and with continued reference to FIG. 3, the object classification system 100 includes a lidar data processing module 82, an image depth determination module 84, a machine learning processing module 86, and at least one vehicle control module 88. As can be appreciated, the module shown can be combined and/or further partitioned in various embodiments.

The lidar data processing module 82 receives as input lidar data 90. The lidar data 90 includes a three dimensional point cloud including distance or depth information and/or intensity that is measured based on reflectivity of a laser light from a lidar of the vehicle. The lidar data 90 is processed to identify the presence of elements 92. For example, the values of depth or distance (or z coordinate) are evaluated and proximal like values and their corresponding location (x, y coordinates) are grouped and stored in an array. This array of like values is then defined as an element.

The lidar data processing module 82 then generates histograms 93 of the data within the bounding box. For example, the lidar data processing module 82 generates a histogram of elevation and a histogram of length based on the x, y coordinates of the data within the bounding box.

The image depth determination module 84 receives as input the identified elements 92 (e.g., the arrays of like values). The image depth determination module 84 generates a bounding box around each of the identified elements 92. For example, a two dimensional ‘box’ or other geometric construct (the most complex being an irregular polygon) is created to surround the element 92. The ‘box’ can be created, for example, based on predefined values for height and width or based on values determined from, for example, largest and/or smallest x and y positions of the like values.

The image depth determination module then determines segments of the element 92 within the box based on the x-y values. For example, the segments can be curved lines, straight lines, etc. determined from the outline of the element 92. The identified segments are then projected against the sides of the box. The results of the projection provide a depth image with respect to the box. One or more values of the depth image are interpolated between the segments. Thus, the depth image is an interpolated depth image 94. In various embodiments, this process is iterated for each identified element 92 in the scene.

The machine learning processing module 86 receives the interpolated depth images 94, the histograms 93 of elevation and length, and a trained ML model 96. The trained ML model 96 can be, for example, a convolutional neural net that is pre-trained with data that has been previously collected, distorted in various ways to account for variation in pose of an object, and classified by other classifiers. The machine learning processing module 86 processes the interpolated depth images 94, and the histograms 93 of elevation and length using the trained ML model 96. The trained ML model 96 provides classifications 98 of each of the elements associated with the interpolated images 94 and the histograms 93.

The vehicle control module 88 receives as input the classifications 98. The vehicle control module 88 controls one or more features of the vehicle 10 based on the classifications 98. For example, the vehicle control module 88 controls a path of the vehicle 10, determines a position of the vehicle 10, and/or generates via control signals 101 and/or control messages 102 based on the classifications 98.

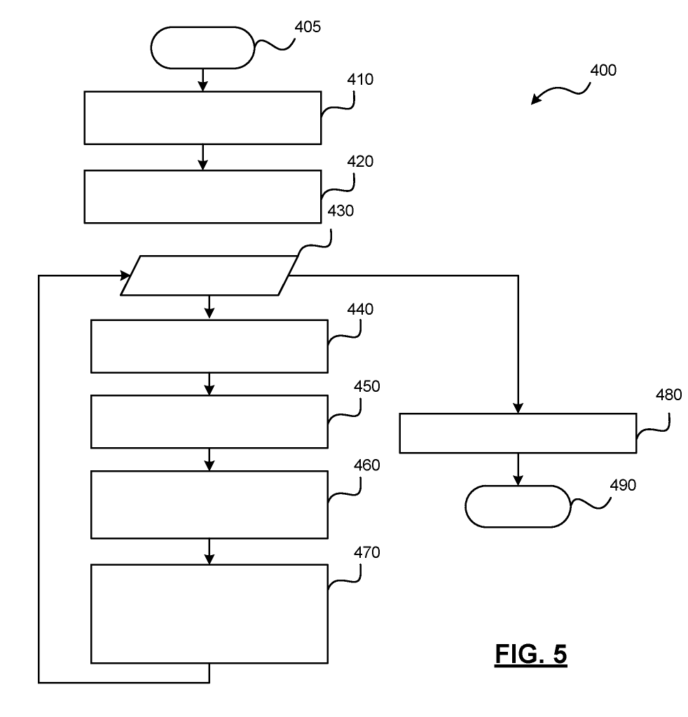

Referring now to FIG. 5, and with continued reference to FIGS. 1-4, a flowchart illustrates a control method 400 that can be performed by the object classification system 100 of FIG. 1 in accordance with the present disclosure. As can be appreciated in light of the disclosure, the order of operation within the method is not limited to the sequential execution as illustrated in FIG. 5, but may be performed in one or more varying orders as applicable and in accordance with the present disclosure. In various embodiments, the method 400 can be scheduled to run based on one or more predetermined events, and/or can run continuously during operation of the autonomous vehicle 10.

In one embodiment, the method may begin at 405. Lidar data corresponding to a scene is obtained at 410. The lidar data is processed to identify elements present within the scene at 420. For each element within the scene at 430, a box having predefined dimensions is drawn around each identified element at 440. Segments of the element are identified at 450, and projected against the sides of the box to obtain an interpolated depth image with respect to the box at 460. The interpolated depth image and a histogram of elevation and length are provided to a ML model (e.g., a trained neural network) at 470. The ML model processes the information and provides an object classification at 480. Thereafter, the object classification is used to determine a location, determine a path, and/or to control movement of the vehicle at 490. The method may end at 490.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An object classification method, comprising:
receiving sensor data associated with an environment of a vehicle;
processing, by a processor, the sensor data to determine an element within a scene;
generating, by the processor, a bounding box around the element;
projecting, by the processor, segments of the element onto the bounding box to obtain a depth image; and
classifying the object by providing the depth image to a machine learning model and receiving a classification output that classifies the element as an object for assisting in control of the autonomous vehicle.

2. The method of claim 1, wherein the machine learning model is an artificial neural network model.

3. The method of claim 1, wherein the interpolated depth image includes depth values of the element with respect to the bounding box.

4. The method of claim 1, further comprising determining a bounding box around the element based on predefined values.

5. The method of claim 1, further comprising determining the bounding box around the element based on values of x and y coordinates of the element.

6. The method of claim 1, wherein the classifying the object is further based on a histogram of elevation values associated with the element.

7. The method of claim 1, wherein the classifying the object is further based on a histogram of length values associated with the element.

8. The method of claim 1, further comprising determining the segments of the element.

9. The method of claim 1, wherein the depth image is an interpolated depth image that includes interpolated values.

10. The method of claim 1, further comprising generating control signals to control the vehicle based on the classification.

11. A system for autonomous driving, comprising:
an object classification module, including a processor, configured to:
receive sensor data associated with an environment of a vehicle;
process, by a processor, the sensor data to determine an element within a scene;
generate, by the processor, a bounding box around the element;
project, by the processor, segments of the element onto the bounding box to obtain a depth image; and
classify the object by providing the depth image to a machine learning model and receiving a classification output that classifies the element as an object for assisting in control of the autonomous vehicle.

12. The system of claim 11, wherein the machine learning model is an artificial neural network model.

13. The system of claim 11, wherein the interpolated depth image includes depth values of the element with respect to the bounding box.

14. The system of claim 11, wherein the object classification module is further configured to determine a bounding box around the element based on predefined values.

15. The method of claim 1, wherein the object classification module is further configured to determine the bounding box around the element based on values of x and y coordinates of the element.

16. The method of claim 1, wherein the object classification module is further configured to classify the objects further based on a histogram of elevation values associated with the element.

17. The method of claim 1, wherein the object classification module is further configured to classify the object further based on a histogram of length values associated with the element.

18. The method of claim 1, wherein the object classification module is further configured to determine the segments of the element.

19. The method of claim 1, wherein the depth image is an interpolated depth image that includes interpolated values.

20. An autonomous vehicle, comprising:
at least one sensor that provides sensor data; and
a controller that, by a processor and based on the sensor data:
receives sensor data associated with an environment of a vehicle;
processes, by a processor, the sensor data to determine an element within a scene;
generates, by the processor, a bounding box around the element;
projects, by the processor, segments of the element onto the bounding box to obtain a depth image; and
classifies the object by providing the depth image to a machine learning model and receiving a classification output that classifies the element as an object for assisting in control of the autonomous vehicle.
